(19) United States
(12) Patent Application Publication
(10) Pub. No.: US 2021/0302675 A1
(43) Pub. Date: Sep. 30, 2021

(54) OPTICAL CONTROLLER SOCKET WITH WRAPPING WATERPROOF STRUCTURE

(71) Applicant: Foshan Ojun Electrical Technology Co., Ltd., Foshan (CN)

(72) Inventors: Changxiong PAN, FOSHAN (CN); Yaoguang XIAO, FOSHAN (CN)

(73) Assignee: Foshan Ojun Electrical Technology Co., Ltd.

(21) Appl. No.: 17/037,836

(22) Filed: Sep. 30, 2020

(30) Foreign Application Priority Data
Mar. 28, 2020 (CN) 202020421309.9

(51) Int. Cl. G02B 6/42; H01R 13/52; H01R 13/631; G02B 6/38

(52) U.S. Cl. CPC G02B 6/4292; G02B 6/3817; H01R 13/631; H01R 13/5202

(57) ABSTRACT

The disclosure discloses an optical controller socket with wrapping waterproof structure including a socket body with an opening at an inner hollow lower end, the lower end opening of the socket body is provided with an end cover, and an upper side of the end cover is fixedly installed with three clamping pieces disposed in the socket body, an upper side of the socket body is formed with plugholes respectively corresponding to three clamping pieces, and an outer side of an upper end of the socket body is wrapped with a waterproof sealing structure.

### CROSS-REFERENCE TO RELATED APPLICATIONS

This application claims priority to Chinese Patent Application No. 202020421309.9 with a filing date of Mar. 28, 2020. The content of the aforementioned applications, including any intervening amendments thereto, are incorporated herein by reference.

### TECHNICAL FIELD

The disclosure relates to the technical field of electric, in particular to an optical controller socket with wrapping waterproof structure.

### BACKGROUND OF THE PRESENT INVENTION

The optical controller is a controller that controls the switch of the lamp by sensing the change of the light source, which is an automatic control device often used for power sources such as street lamps, lighting lamps, and in order to cooperate with the optical controller and allow the optical controller more safer in use, the optical controller socket is often used to provide power to the optical controller, however, connections between the currently used optical controller socket and the optical controller have a poor waterproof sealing effect.

### SUMMARY OF PRESENT INVENTION

The object of the disclosure is to provide an optical controller socket with wrapping waterproof structure in order to solve the above problems, which has the advantages of greatly improving the waterproof sealing effect of the connections between the optical controller socket and the optical controller, please referring to the following description for details.

In order to achieve the above object, the disclosure provides the following technical solution.

An optical controller socket with wrapping waterproof structure provided by the disclosure includes a socket body with an opening at an inner hollow lower end, the lower end opening of the socket body is provided with an end cover, and an upper side of the end cover is, fixedly installed with three clamping pieces disposed in the socket body, an upper side of the socket body is formed with plugholes respectively corresponding to three clamping pieces, and an outer side of an upper end of the socket body is wrapped with a waterproof sealing structure.

Preferably, the waterproof sealing structure includes a ferrule, and the ferrule is sleeved in an annular caulking groove formed on the outer side of the socket body, the upper and lower ends of the ferrule are fixedly provided with inward convex edges, an inner edge of the upper convex edge is fixedly connected to a collar along its edge, an outer protrusion is disposed on the outer side of the collar, and the ferrule, the collar and the outer protrusion are integrally formed and made of rubber material.

Preferably, an upper side of the end cover is fixedly provided with a mounting seat, and an outer side of the mounting seat is provided with three mounting grooves for inserting and installing the clamping pieces.

Preferably, the clamping piece is composed of two elastic metal pieces abutting against each other, and lower ends of the two elastic metal pieces are fixedly connected to each other.

Preferably, an outer thread is provided on the outer side of the upper end of the socket body.

Preferably, a sealing gasket is provided between the end cover and the socket body.

Preferably, the plughole is fan-shaped in appearance.

Preferably, several threading holes are formed on the end cover.

The beneficial effect is that the waterproof sealing structure wrapped on the outer side of the upper end of the socket body may greatly improve the waterproof sealing effect of the connections between the optical controller socket and the optical controller, the sealing gasket may improve tightness of the connections between the end cover and the socket body, and the plughole is fan-shaped to facilitate threadedly assembly connection of the optical controller socket and the optical controller.

### DESCRIPTION OF THE DRAWINGS

In order to more clearly explain the technical solution in the embodiments of the disclosure or the prior art, the drawings that need to be used in the description of the embodiments or the prior art will be briefly introduced in the following, obviously, the drawings in the following description are just some embodiments of the disclosure, and to those of ordinary skill in the art, other drawings may be obtained based on these drawings without creative effort.

FIG. 1 is a front view of the disclosure;

FIG. 2 is a perspective view of FIG. 1 of the disclosure;

FIG. 3 is a perspective view of FIG. 1 of the disclosure from another direction;

FIG. 4 is an exploded perspective view of A of FIG. 2 of the disclosure;

FIG. 5 is an assembly schematic diagram of the optical controller socket and the optical controller of the disclosure.

The reference signs are explained as follows: 1. Socket body; 2. Waterproof sealing structure; 2a. Ferrule; 2b. Collar; 2c. Outer protrusion; 3. Outer thread; 4. End cover; 4a. Threading hole; 5. Plughole; 6. Sealing gasket; 7. Annular caulking groove; 8. Mounting seat; 9. Mounting groove; 10. Clamping piece.

### DETAILED DESCRIPTION OF PREFERRED EMBODIMENTS

In order to make the object, technical solution and advantages of the disclosure clearer, the technical solution of the disclosure will be described in detail below. Obviously, the described embodiments are only a part of, rather than all the embodiments of the disclosure. Based on the embodiments of the disclosure, all other embodiments obtained by those of ordinary skill in the art without creative effort shall fall within the protection scope of the disclosure.

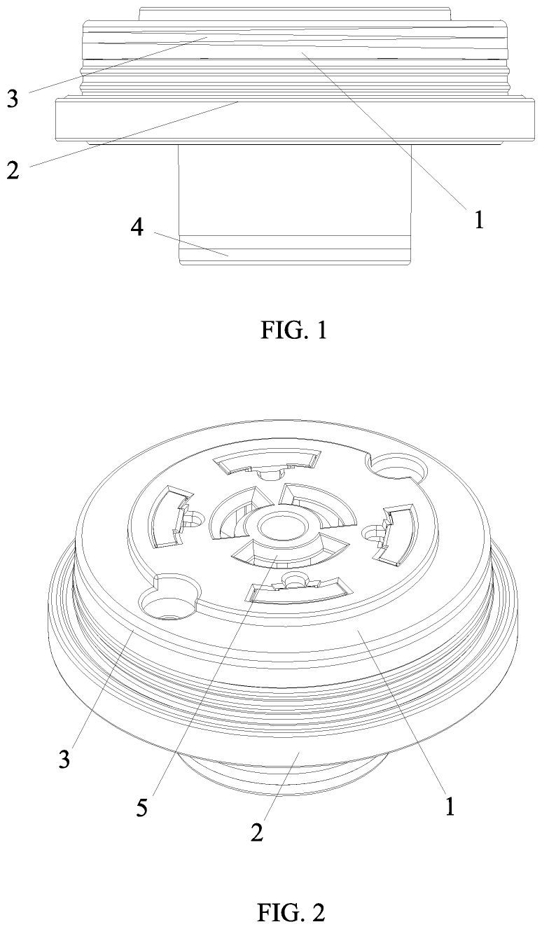

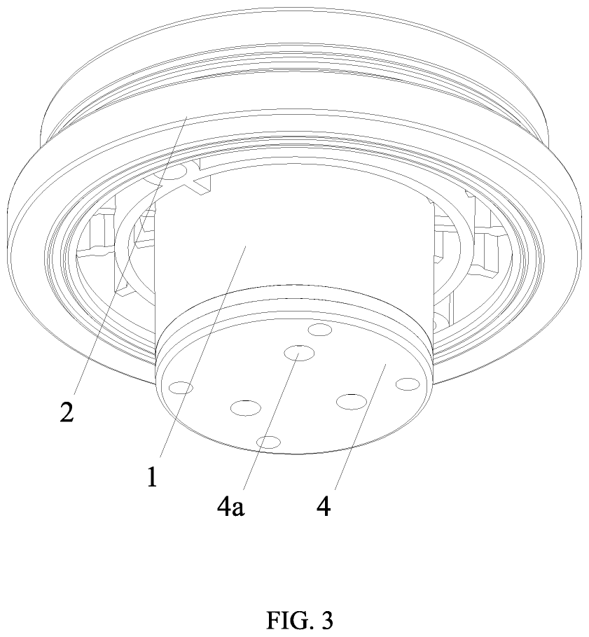

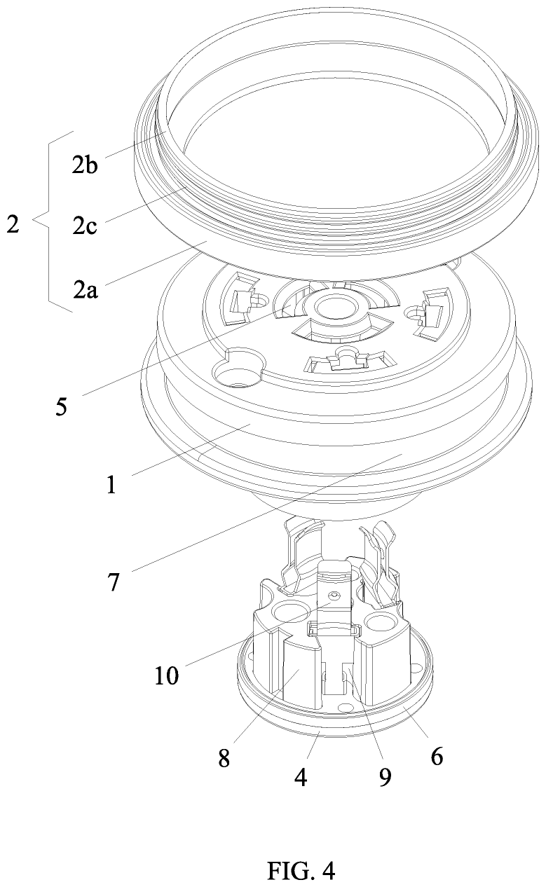

Referring to FIGS. 1 to 5, the disclosure provides an optical controller socket with wrapping waterproof structure, including a socket body 1 with an opening at an inner hollow lower end, the lower end opening of the socket body 1 is provided with an end cover 4, and an upper side of the end cover 4 is fixedly installed with three clamping pieces 10 disposed in the socket body 1, an upper side of the socket body 1 is formed with plugholes 5 respectively corresponding to three clamping pieces 10, and an outer side of an upper end of the socket body 1 is wrapped with a waterproof sealing structure 2.

The waterproof sealing structure 2 includes a ferrule 2a, and the ferrule 2a is sleeved in an annular caulking groove 7 formed on the outer side of the socket body 1. The upper and lower ends of the ferrule 2a are fixedly provided with inward convex edges, an inner edge of the upper convex edge is fixedly connected to a collar 2b along its edge, an outer protrusion 2c is disposed on the outer side of the collar 2b, and the ferrule 2a, the collar 2b and the outer protrusion 2c are integrally formed and made of rubber material.

An upper side of the end cover 4 is fixedly provided with a mounting seat 8, and an outer side of the mounting seat 8 is provided with three mounting grooves 9 for inserting and installing the clamping pieces 10, which facilitates detachable installation of the clamping pieces 10 and the stability of the installation of the clamping pieces 10.

The clamping piece 10 is composed of two elastic metal pieces abutting against each other, and lower ends of the two elastic metal pieces are fixedly connected to each other.

An outer thread 3 is provided on the outer side of the upper end of the socket body 1, which is used to realize the threaded connection between the socket body 1 and the optical controller

A sealing gasket 6 is provided between the end cover 4 and the socket body 1, which improves the tightness between the end cover 4 and the socket body 1.

The plughole 5 is fan-shaped in appearance, which facilitates the rotation of the optical controller insertion post in the plughole 5.

Several threading holes 4a are formed on the end cover 4, which are used to pass the wire, and gaps between the threading holes 4 and the wire may be filled and fixed with waterproof glue.

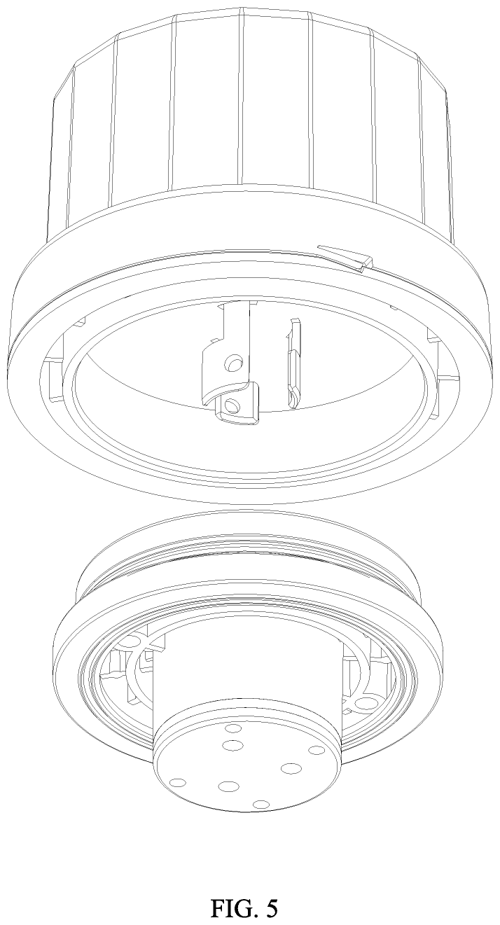

With the above structure, the waterproof sealing structure 2 is nested and wrapped in the annular caulking groove 7 formed on the outer side of the upper end of the socket body 1, which can ensure that the waterproof sealing structure 2 is not easy to move up and down, and when the optical controller socket is assembled with and plugged into optical controller, the tightness of the connections between the optical controller socket and the optical controller may be greatly improved, as shown in FIG. 5 of the specification, the optical controller insertion post is inserted into the plughole 5 to the socket body 1, which may realize connection with the clamping piece 10.

The waterproof sealing structure 2 wrapped on the outer side of the upper end of the socket body 1 may greatly improve the waterproof sealing effect of the connections between the optical controller socket and the optical controller, the sealing gasket 6 may improve tightness of the connections between the end cover 4 and the socket body 1, and the plughole 5 is fan-shaped to facilitate threadedly assembly connection of the optical controller socket and the optical controller.

The above are only specific embodiments of the disclosure, but the protection scope of the disclosure is not limited thereto, and any person skilled in the art may easily conceive change or replacement within the technical scope disclosed by the disclosure, which shall be covered within the protection scope of the disclosure. Therefore, the protection scope of the disclosure shall be based on the protection scope of the claims.

We claim:

1. An optical controller socket with wrapping waterproof structure, comprising a socket body (1) with an opening at an inner hollow lower end, the lower end opening of the socket body (1) is provided with an end cover (4), and an upper side of the end cover (4) is fixedly installed with three clamping pieces (10) disposed in the socket body (1), an upper side of the socket body (1) is formed with plugholes (5) respectively corresponding to three clamping pieces (10), and an outer side of an upper end of the socket body (1) is wrapped with a waterproof sealing structure (2).

2. The optical controller socket with wrapping waterproof structure of claim 1, wherein the waterproof sealing structure (2) comprises a ferrule (2a), and the ferrule (2a) is sleeved in an annular caulking groove (7) formed on the outer side of the socket body (1), the upper and lower ends of the ferrule (2a) are fixedly provided with inward convex edges, an inner edge of the upper convex edge is fixedly connected to a collar (2b) along its edge, an outer protrusion (2c) is disposed on the outer side of the collar (2b), and the ferrule (2a), the collar (2b) and the outer protrusion (2c) are integrally formed and made of rubber material.

3. The optical controller socket with wrapping waterproof structure of claim 1, wherein an upper side of the end cover (4) is fixedly provided with a mounting seat (8), and an outer side of the mounting seat (8) is provided with three mounting grooves (9) for inserting and installing the clamping pieces (10).

4. The optical controller socket with wrapping waterproof structure of claim 1, wherein the clamping piece (10) is composed of two elastic metal pieces abutting against each other, and lower ends of the two elastic metal pieces are fixedly connected to each other.

5. The optical controller socket with wrapping waterproof structure of claim 1, wherein an outer thread (3) is provided on the outer side of the upper end of the socket body (1).

6. The optical controller socket with wrapping waterproof structure of claim 1, wherein a sealing gasket (6) is provided between the end cover (4) and the socket body (1).

7. The optical controller socket with wrapping waterproof structure of claim 1, wherein the plughole (5) is fan-shaped in appearance.

8. The optical controller socket with wrapping waterproof structure of claim wherein several threading holes (4a) are formed on the end cover (4).
